(19) United States
(12) Patent Application Publication
(10) Pub. No.: US 2008/0075554 A1
(43) Pub. Date: Mar. 27, 2008

(54) Keylocking threaded insert

(76) Inventor: George T. Margelos, Arlington Heights, IL (US)

Correspondence Address: FAY SHARPE LLP, 1100 SUPERIOR AVENUE, SEVENTH FLOOR, CLEVELAND, OH, 44114, US

(21) Appl. No.: 11/901,919

(22) Filed: Sep. 19, 2007

Related U.S. Application Data
(60) Provisional application No. 60/846,643, filed on Sep. 22, 2006.

(51) Int. Cl. F16B 39/28

(52) U.S. Cl. 411/110; 29/527.1; 425/547

(57) ABSTRACT

A keylocking threaded insert with an outer cylindrical surface in the form of an external thread adapted to be screwed into a cylindrical bore of a parent part formed from a given material and having an internal thread matching the external thread of the insert. The insert has an unitary body formed by metal particles with a particle size of less than about 20 microns and at least two diametrically located, axially extending locking grooves formed in the external surface and intersecting the external thread.

### CROSS-REFERENCE TO RELATED APPLICATIONS

This application claims priority from and benefit of the filing date of U.S. provisional application Ser. No. 60/846,643, filed Sep. 22, 2006, and said prior application is hereby expressly incorporated by reference herein.

The invention relates to a device for providing a threaded bore in a parent part and more particularly to a keylocking threaded insert for mounting into the bore of the parent part.

### INCORPORATION BY REFERENCE

Keylocking threaded inserts are formed by a screw machine operation providing an external thread and an internal thread of the desired specification. A parent metal part is drilled to produce a bore that is threaded to match the external thread of the insert. The insert is then screwed into the bore of the parent part and locked in position by driving keys fitting into external grooves in the outside thread of the insert so the key deforms the threads on the parent part to lock the insert into the parent part. Consequently, the inner thread of the insert meets the specification of the thread for the opening. In this manner, a soft parent part can be provided with a relatively harder threaded bore having high precision threads. Furthermore, a defective thread can be replaced. This technology dates back to the 1950's and is illustrated in many patents, such as Neuschotz U.S. Pat. No. 2,855,970, Neuschotz U.S. Pat. No. 3,270,792; Neuschotz U.S. Pat. No. 3,371,402; Neuschotz U.S. Pat. No. 3,388,621; Neuschotz U.S. Pat. No. 3,394,448; Neuschotz U.S. Pat. No. 3,447,356; Neuschotz U.S. Pat. No. 3,537,118; Neuschotz U.S. Pat. No. 3,667,526 and Guevara et al. U.S. Pat. No. 4,895,485 and Schron U.S. Pat. No. 5,617,623. These representative patents are incorporated by reference herein as background information illustrating keylocking threaded inserts of the type improved by the present invention.

In the past, keylocking threaded inserts are produced by a screw machine that provides a cylindrical blank and adds an internal and external thread. By a separate machining operation, one or two sets of diametrically opposed grooves are broached into the outside surface of the insert to intersect the outside thread. The broached grooves each have a profile for receiving an axially insertable elongated key that locks the insert in the parent part after it has threaded into the bore of the parent part. Broaching the external grooves causes a distinct burr in the external thread, which burr must be removed by appropriate grinding or polishing operation. Thus, the screw machine insert must be oriented for broaching the grooves and must then be subjected to a burr removing operation. This complex manufacturing technique requires expensive equipment and high labor cost before the insert is ready for mounting the axially movable keys and then shipment to the assembled insert to the ultimate user.

### THE INVENTION

The present invention relates to a technique for manufacturing keylocking threaded inserts which does not require orientation for broaching and subsequent deburring. Thus, the invention substantially reduces the handling cost and labor cost associated with producing a standard keylocking threaded insert.

In accordance with the present invention there is provided a novel keylocking threaded insert having an outer cylindrical surface in the form of an external thread adapted to be screwed into a cylindrical bore of a parent part formed from a given material. The cylindrical bore of the parent part has an internal thread matching the external thread of the insert. Thus, the insert can be screwed into the bore. The novel insert has a unitary body formed by very small metal particles having a particle size of less than 20 microns. Furthermore, the unitary body has at least two diametrically located, axially extending locking grooves formed in the external surface of the body and intersecting the external thread of the insert body. Consequently, the paddle of a standard key is pushed into the groove without deforming the external thread. The insert, with assembled keys, is then screwed into the threaded port of the parent part and the keys are driven into the groove. This action deforms the threads of the parent part to lock the insert in place. In accordance with the invention, particles are sintered together and the body of the insert is molded from pellets of the very small particles. Indeed, the insert body is formed from a commercial metal injection molding process. In this process, the small metal particles are mixed with a plastic binder and formed into feedstock generally in the shape of small pellets. A novel mold receives the feedstock pellets by an injection molding procedure to form a slightly enlarged version of the insert. This enlarged version or green part is then heated to remove the binder and then heated further to sinter the particles and reduce the green part to the desired shape. Thus, the body of the insert is formed in a single molding step that provides the necessary threads and the desired axially extending, key receiving grooves. In accordance with the preferred embodiment of the invention, the body has a bore concentric with the outer surface and the bore includes an internal thread. This constitutes a standard keylocking threaded insert, such as shown in Neuschotz U.S. Pat. No. 2,855,970 and Neuschotz U.S. Pat. No. 3,270,792. The novel insert can be a plug or an extended rod having only an external thread and diametrically opposed locking groove. In these two broader uses of the present invention, no burrs are formed and a one step operation makes the insert body without machining operations.

In summary, the present invention involves an ejection molded component forming the body of a keylocking insert, where the grooves are cast in place. The body need not be reoriented for broaching and subsequently deburred.

In accordance with another aspect of the present invention, there is provided a method of making a keylocking threaded insert having a desired configuration and axially extended locking grooves. The method involves mixing particles having a particle size of less than 20 microns with a plastic binder, forming the mixture into feedstock pellets, providing a mold with the desired configuration, injection molding the mixture into the mold to form an enlarged version or green part matching the desired configuration of the insert body. Then the green part is heated to remove the binder and then heated to sinter the particles and reduce the enlarged version or green part to the desired size. This is normally a reduction of about 20%.

In accordance with another aspect of the present invention, a novel mold is constructed to produce the injection molded body for the threaded insert. The mold includes two outer sections with semi-cylindrical portions defining the mirror image of the outer thread for the insert body. These sections define a parting line for the mold. At the parting line, axially movable inserts are provided to define the profile of the axially extending, key receiving grooves of the insert. A center core concentric with the mirror image thread is rotatably mounted to define the internal threaded bore of the insert. The novel mold includes the two parting line defining sections, at least two inserts movable axially at the parting line area and a center rotatable core for defining the internal threaded bore of the insert. By assembling these mold pieces, the remaining cavity defines the enlarged size of the green part. A green part is injection molded using the novel mold. The green part is then heated to remove the binder and the part is then heated to sinter the small particles forming the material injection molded in the mold. The enlarged size of the green part cavity is normally 20% larger than the desired configuration of the body for the novel insert. Manufacturing of the insert body is essentially a one step operation having no need for subsequent orientation to broach the key grooves or an operation for deburring the resulting groove.

The primary object of the present invention is the provision of a standard keylocking threaded insert, where the body of the insert need not be oriented for broaching or deburred after broaching.

Yet another object of the present invention is the provision of an insert, as defined above, which insert has a body formed from a metal injection molding process.

Another object of the present invention is the provision of an insert, as defined above, which insert is less costly to manufacture.

Still a further object of the present invention is the provision of a novel method of making a body for a keylocking threaded insert and a novel mold used for performing the method.

These and other objects and advantages will become apparent from the following description taken together with the accompanying drawings.

### BRIEF DESCRIPTION OF DRAWINGS

FIG. 1 is a pictorial view of a standard keylocking threaded insert;

FIG. 2 is a flow chart of the manufacturing procedure used in making the prior art insert shown in FIG. 1;

FIG. 3 is a cross-sectional view of the preferred embodiment of the present invention with two keys;

FIG. 4 is a cross-sectional view taken generally along line 4-4 of FIG. 3;

FIG. 5 is a flow chart of the method of making an insert as shown in FIGS. 3 and 4 with progressive schematic illustration of the method steps;

FIG. 6 is an enlarged partial cross-sectional view taken generally along line 4-4 of FIG. 3;

FIG. 7A is an enlarged partial cross-sectional view taken generally along line 7A-7A of FIG. 3;

FIG. 7B is an enlarged partial cross-sectional view taken generally along line 7B-7B of FIG. 3;

FIG. 8 is a top view of a novel mold used for injection molding of the insert body used in the preferred embodiment of the present invention; and,

FIG. 9 is a side elevational view in partial cross-section showing a keylocking threaded insert or plug without a central threaded bore.

### PREFERRED EMBODIMENT OF THE INVENTION

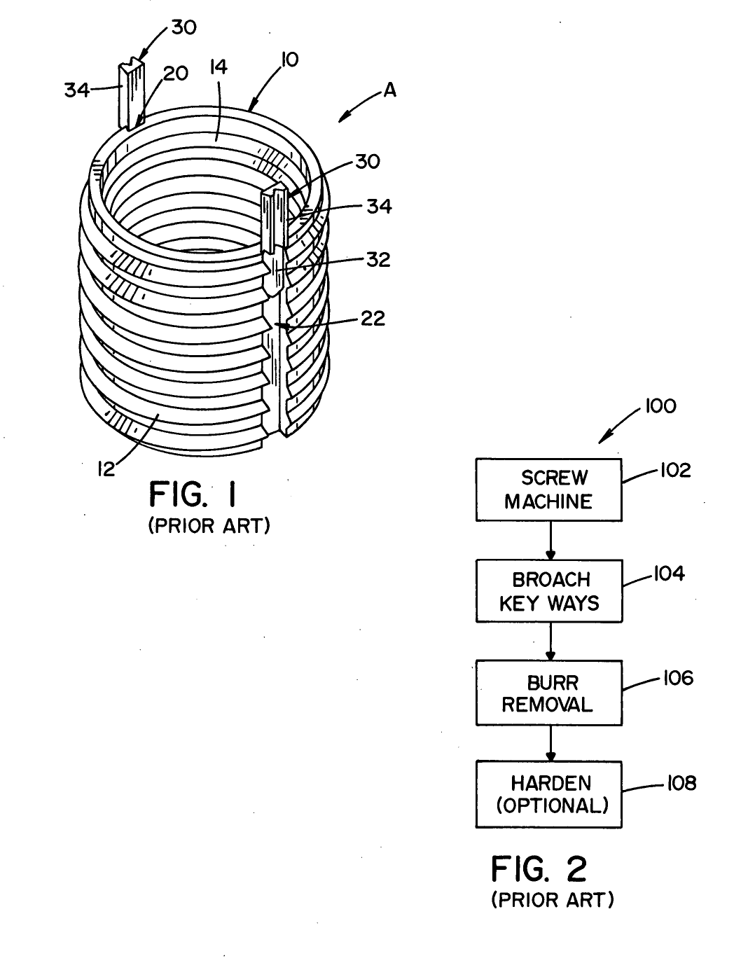

Since the mid 1950's, a substantial industry has been developed for producing keylocking threaded inserts as shown in Neuschotz U.S. Pat. No. 2,855,970. The inserts have bodies in a variety of sizes. A representative prior art insert A is illustrated in FIG. 1 and includes a metal body machined with an outer thread 12 and an inner thread 14. Diametrically opposed key receiving grooves 20, 22 are broached into body 10 and hold keys 30, each having a lower paddle 32 frictionally held in one of the grooves and an upper key head 34 for distorting the threads of the bore in which insert A is threaded. In practice, a parent part, not shown, is drilled and tapped to threadably receive insert A. The insert is screwed into the tapped threaded bore with keys 30 assembled in their upper non-distortion positions, as shown in FIG. 1. After insert A is threaded into the bore of the parent part, keys 30 are driven downwardly into the grooves 20, 22 to distort the threads of the receiving bore, as explained in Neuschotz U.S. Pat. No. 2,855,970. Insert A is produced by a method schematically illustrated as flow chart 100 in FIG. 2. The prior art method involves a screw machine operation for sizing body 10 and for providing machined threads 12, 14. After the body has been produced by a screw machine operation involving a plurality of machining operations as indicated by block 102, the body is oriented for broaching two or more grooves 20, 22 as indicated by block 104. This broaching process causes burrs to form on outer thread 12. Such burrs must be removed, so insert A can be easily threaded into the parent part. This burr removal operation involves labor costs and manufacturing time and is indicated by block 106. Body 10 of the insert is first machined. It is then broached and the burrs are removed. In some instances, metal of body 10 must be hardened to realize the necessary physical characteristics. This optional operation is indicated by block 108. Keylocking threaded insert A, which has been manufactured through the years, is produced by a costly machining process indicated by the method shown in flow chart 100 in FIG. 2. The present invention relates to a procedure for manufacturing a novel threaded insert without requiring the complex machining and deburring operations to make body 10.

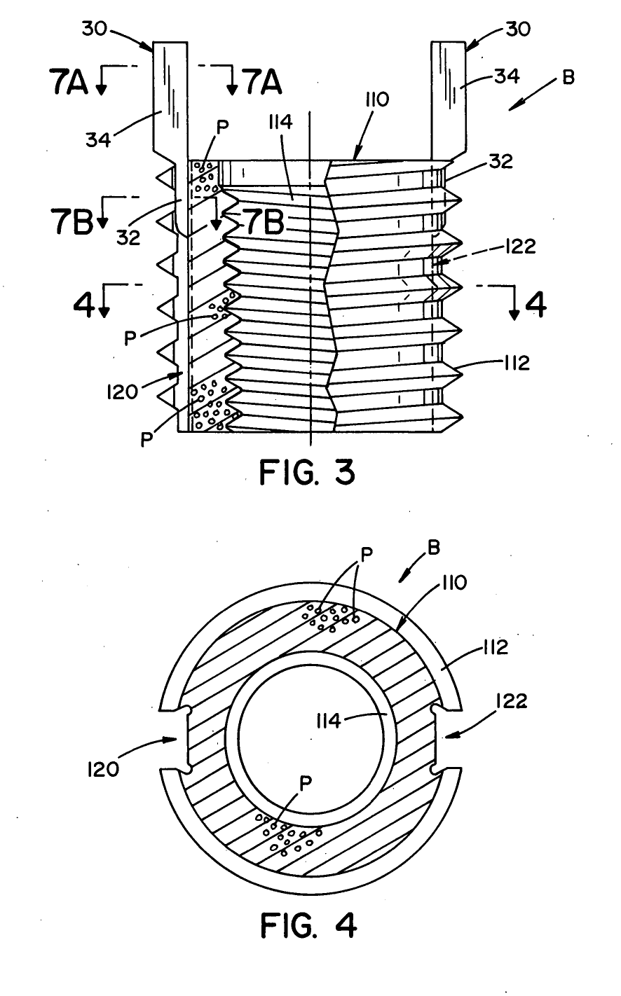

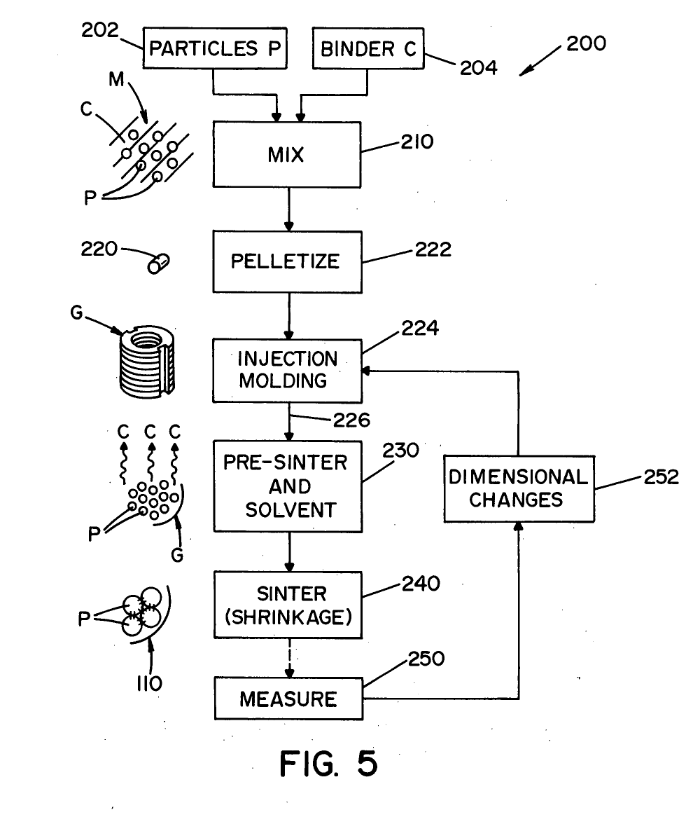

The preferred embodiments of the present invention involves insert B as shown in FIGS. 3 and 4 with the same general features as insert A. Common elements are indicated by the same numbers. The difference between novel insert B and standard insert A is the body 110 of insert B. This body is formed by metal particles P with a particle size of less than about 20 microns and preferably between 1-20 microns. Body 110 is formed by a single metal injection molding process so that there is no need to orient the part to broach grooves 20, 22 or to subsequently remove burrs from the body preparatory to assembling keys 30 into groves 120, 122. In accordance with the invention, molded body 110 of insert B has outer thread 112 and inner thread 114 and is formed by the process illustrated in flow chart 200 in FIG. 5. In accordance with the invention, finely divided metal particles P from a hopper designated block 202 are compounded and mixed with plastic binder C, which is a fluid binder. The particles are less than 10 microns and generally 5 microns. The binder is two phase including a high melting point polymer and a low melting point wax. When the particles and binder are mixed at step or block 210 it produces a mixture M, as shown in FIG. 5. This mixture is then compacted into small molding pellets 220 by a pelletizing machine shown as block 222. Pellets 220 are feedstock that is injection into a mold to form a green part as indicated by block 224. The injection molding process of block 224 produces green part G transported along line 226 to the process step shown as block 230. The mold is at least 15-20% larger than the desired size of body 110. Green part G is slightly larger than the desired size of body 110. Operation or step 230 drives off binder C. The two binder components are successively removed, the lighter wax component first, followed by the polymer component. This can be done in various ways. In one procedure a solvent liquid leaches out or removes the wax, followed by a thermal method to remove the polymer. This debinding results in a part consisting of metal particles or power only. The ratio of metal to binder is approximately 90-95% by weight of powder. Green part G including particles P and binder C is pre-sintered and subjected to a solvent. This step removes the two phase binder C from particles P and partially sinters particles P together as a unit. The internal makeup of the green part when pre-sintered at step 230 is illustrated at the left of flow chart 200. Particles P are joined together to maintain the structural integrity of the green part. Thereafter, the pre-sintered green part with the two phase liquid binder C removed is heated in a high temperature sintering step represented by block 240. The temperature is in the range of 2300-2500° F. This reduces the size of green part G by about 20%. In dimensionalizing the novel process, the mold produces a green part that is an enlarged version of the final body 110. Sintered body 110 is measured, as indicated by block 250. If the size is not within the desired limits, the mold of injection molding step 224 is dimensionally changed as indicated by block 252. The sintered particles P, are shown on the left of block 240 and are held together by an adhesion between the particles caused by the high temperature sintering operation. After the mold has been changed to produce a body within the desired dimensional limits, the method of flow chart 200 is then ready for mass production. In summary, fine metal particles are mixed with a plastic liquid binder and then pelletized to produce a feedstock of pellets 220 for injection molding of a green part as indicated by step or block 224. The metal injection molding process is performed in a specially designed mold to form a green part that is first pre-sintered and subjected to a solvent as indicated by step 230. This removes the liquid binder from particles P. Removal of the two phase binder can be done by a thermal process. However, in practice a solvent bath is used as an initial step prior to the thermal processing. Thereafter, the green part is put through a high temperature sintering furnace where the remaining binder is removed. The powder particles fuse together to reach 93-97% of their theoretical density. During this critical high temperature step, the green part shrinks approximately 20% to the desired final dimensions of body 110. Body 110 has outside thread 112 and inside thread 114. There are many applications for this body. The main use is for a keylocking threaded insert where the thread strength of the part must be greater than possible by tapping the parent material. Furthermore, the novel insert is used to repair damaged threads on a parent part. The keylocking insert is installed by screwing the insert into the threaded hole of the parent part or material and then driving down the two or four keys 30 to a position where heads 34 are flushed with the top of body 110. By tapping down the two or four keys into the parent material, the keylocking threaded insert is anchored in place as is well known in the art. Only two diametrically spaced grooves 120, 122 are illustrated; however, two more grooves could be placed orthogonally to the illustrated grooves. In the preferred embodiment of the invention, four grooves are employed in body 110; however, it is not necessary to illustrate this standard feature.

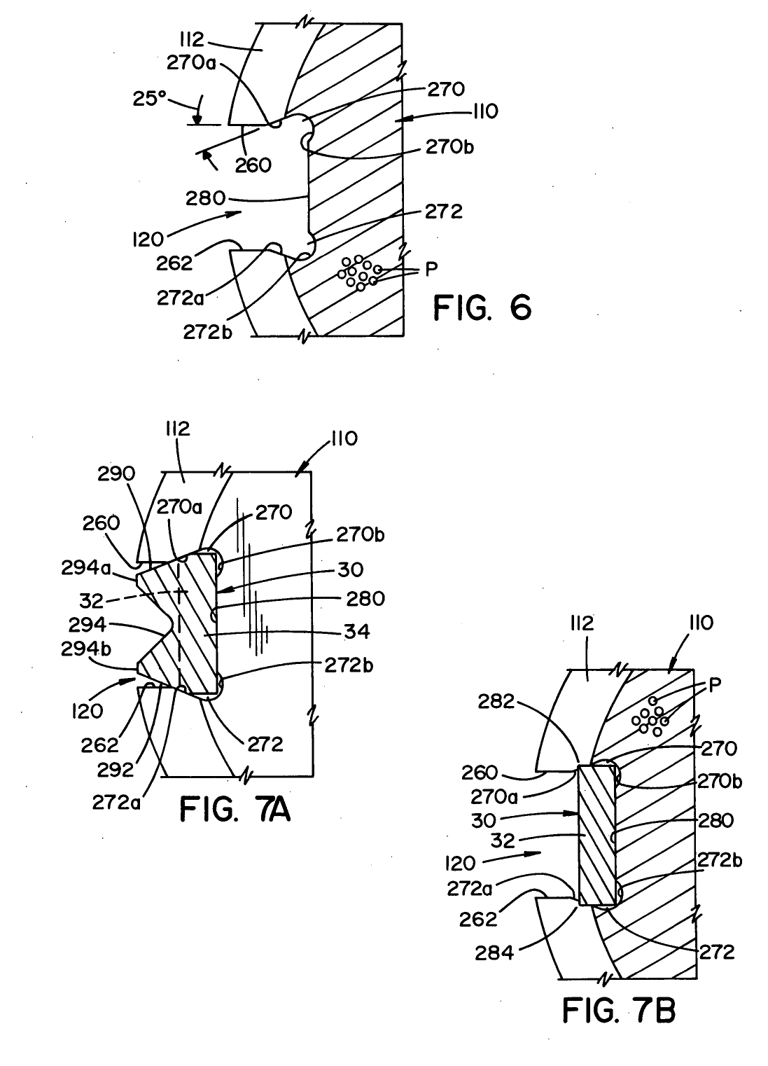

In accordance with another aspect of the present invention, groove 120 illustrated in FIGS. 6, 7A and 7B has a novel cross-sectional profile, best shown in FIG. 6. Generally parallel sidewalls 260, 262 extend to undercut portions 270, 272 at the bottom of groove 20. The undercut portions include sidewalls 270a, 272a flared outwardly from sidewalls 260, 262 to define cylindrical recess portions 270b, 272b. These cylindrical recesses have a generally arcuate cross-sectional shape extending between walls 270a, 272a and the outside edge of bottom key engaging platform 280. This flat platform has a width less than the spacing between sidewalls 260, 262 to form an abutment for the backside of key 30. Undercut portions 270, 272 allow easy insertion of downwardly extending paddles 32 of key 30, as best shown in FIG. 7B. There is an interference fit at corners 282 and 284. Angled sidewalls 270a, 272a capture paddle 32 and push the paddle against bottom platform 280 for a tight fit. This allows uniform locking forces holding key 30 for shipment and subsequent driving of key 30 to groove 120. Recesses 270b, 272b combine with platform 280 for directing any obstructions outwardly from paddle 32. Sidewalls 270a, 272a are at an angle of about 25° with parallel sidewalls 260, 262, respectively. Head 34 of key 30 has angled sidewalls 290, 292 matching the sidewalls 270a, 272a for smooth insertion of head 34 into groove 120. To enhance the deforming action of head 34, it has trough 294 formed by upstanding portions 294a, 294b. These portions collapse inwardly during the locking action. In the illustrated embodiment of the invention, two diametrically opposed grooves are used; however, in the preferred implementation of the invention four grooves are spaced evenly around the circumference of insert body 110.

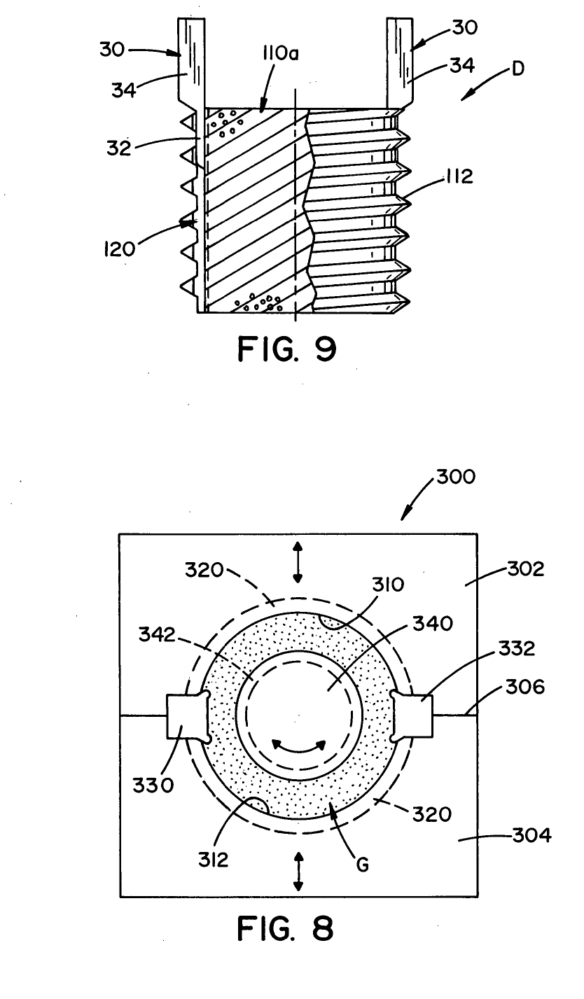

In accordance with the invention, the metal injection molding procedure disclosed as step or block 224 in FIG. 5 utilizes novel mold 300, illustrated in FIG. 8. This mold has two inwardly movable sections 302, 304 to define a parting line joining section 306. Semi-cylindrical portions 310, 312 include the mirror image 320 of thread 112 for the final insert B. Sections 302, 304 are moved together and define the parting line 306. On the parting line are slidable inserts 330, 332 for forming the grooves 120, 122, as shown in FIG. 4. Only two mold inserts are illustrated; however, in practice four inserts are used with another insert at the top of mold 300 and another insert at the bottom of the mold. Mold 300 is designed to injection mold body 110 and includes a rotatable core member 340. When the various pieces of mold 300 are in the positions shown in FIG. 8, green part G of the insert body is molded. This part G is held together by the binder and has a shape determined by the pieces or elements of mold 300. After the molding process has been completed, core member 340 is removed by threading the member outwardly. It has the mirror image 342 of thread 114. After the core member has been removed by threading action, inserts 330, 332 are withdrawn by movement in a direction perpendicular to the plane of the view shown in FIG. 8. Thereafter, sections 302, 304 are moved apart and green part G is extracted from mold 300 for subsequent processing as indicated by the method shown in FIG. 5. To form the next green part, sections 302, 304 are moved together and inserts 330, 332 are again moved into the area of parting line 306. Core member 340 is moved into the position shown in FIG. 8. The mold now is ready for injection molding of the next green part. In practice, several molds 300 are used for simultaneously molding green parts G. The green parts are then pre-sintered and sintered into the desired final size and configuration for the body 110 of insert B.

The invention can be used in making many different configurations and sizes of insert bodies 110. Furthermore, plug insert D as shown in FIG. 9 can be produced using the present invention. In this embodiment, there is no internal thread 114. Body 110a is solid, with an outside thread 112 and grooves for receiving locking keys 30. A shaft can be formed integrally with body 110a to produce an extension of plug D. Indeed, the invention involves the formation of molded body 110 or 110a by the metal injection molding procedure disclosed in FIG. 5. Other insert bodies can be molded as long as they include an outside thread and are formed in a single molding operation from ultra fine particles.

In summary, the invention uses a powder metallurgy process, but instead of compressing the powders, the powders are actually molded into shape using standard plastic technology injection molding equipment. Because the powders are extremely fine metal dust, the resulting specific densities, after sintering or fusing, of the powders range from 93%-97% of full density. The properties of body 110 are nearly identical in resulting properties to wrought and fully dense metal. Fine metal powder or particles, either prealloyed to the desired chemistry or mixed as elemental constituents to the proper ratios of the desired alloy, are mixed together with a polymeric and wax binder. The purpose of the binders is two-fold. Firstly, the binder allows a high concentration of metal powders to be molded at a relatively low molding temperatures of 300-500 degrees Fahrenheit. Secondly, the binder holds the powders together. After the part is molded, the purpose of the binding material is concluded and the process removes the binder successively by lower melting of the wax to higher melting of the polymer. Finally the powder is fused or sintered together in a high temperature, vacuum furnace that reaches temperatures typically in excess of 2300 degrees Fahrenheit. The ratio of metal to binder components is approximately 90-95% by weight powders to remainder binder components at the start. After processing, the percentage is greater than 98%.

Having thus defined the invention, the following is claimed:

1. A keylocking threaded insert with an outer cylindrical surface in the form of an external thread adapted to be screwed into a cylindrical bore of a parent part formed from a given material and having an internal thread matching said external thread of said insert, said insert has an unitary body formed by metal particles with a particle size of less than about 20 microns and at least two diametrically located, axially extending locking grooves formed in said external surface and intersecting said external thread.

2. An insert as defined in claim 1 wherein said particles are sintered together.

3. An insert as defined in claim 2 wherein said body is molded from pellets of said particles.

4. An insert as defined in claim 1 wherein said body is molded from pellets of said particles.

5. An insert as defined in claim 2 wherein said grooves each have a profile shaped to receive an axially movable, elongated key with a tongue fitting into said groove and a locking element driven into said groove after said insert is screwed into said bore.

6. An insert as defined in claim 5 wherein said external thread has a radial depth and each of said profiles has an inner portion below said depth to receive said tongue and an outer portion intersecting said matching threads and having a rectangular shape with a width to receive said locking element for locking said insert into said base.

7. An insert as defined in claim 6 wherein said inner portion includes undercut portion wider than said width and a bottom key engaging axial platform.

8. An insert as defined in claim 1 wherein said grooves each have a profile shaped to receive an axially movable, elongated key with a tongue fitting into said groove and a locking element driven into said groove after said insert is screwed into said bore.

9. An insert as defined in claim 8 wherein said external thread has a radial depth and each of said profiles has an inner portion below said depth to receive said tongue and an outer portion intersecting said matching threads and having a rectangular shape with a width to receive said locking element for locking said insert into said base.

10. An insert as defined in claim 9 wherein said inner portion includes undercut portion wider than said width and a bottom key engaging axial platform.

11. An insert as defined in claim 2 wherein said body is injected molded from said particles.

12. An insert as defined in claim 11 wherein said grooves each have a profile shaped to receive an axially movable, elongated key with a tongue fitting into said groove and a locking element driven into said groove after said insert is screwed into said bore.

13. An insert as defined in claim 1 wherein said body is injected molded from said particles.

14. An insert as defined in claim 13 wherein said grooves each have a profile shaped to receive an axially movable, elongated key with a tongue fitting into said groove and a locking element driven into said groove after said insert is screwed into said bore.

15. An insert as defined in claim 11 wherein said body has a bore concentric with said outer surface.

16. An insert as defined in claim 15 including an internal thread on said bore in said body.

17. An insert as defined in claim 13 wherein said body has a bore concentric with said outer surface.

18. An insert as defined in claim 17 including an internal thread on said bore in said body.

19. An insert as defined in claim 1 wherein said body has a bore concentric with said outer surface.

20. An insert as defined in claim 19 including an internal thread on said bore in said body.

21. An insert as defined in claim 19 wherein said particles are ferrous metal particles.

22. An insert as defined in claim 13 wherein said particles are ferrous metal particles.

23. An insert as defined in claim 8 wherein said particles are ferrous metal particles.

24. An insert as defined in claim 4 wherein said particles are ferrous metal particles.

25. An insert as defined in claim 2 wherein said particles are ferrous metal particles.

26. An insert as defined in claim 1 wherein said particles are ferrous metal particles.

27. An insert as defined in claim 1 wherein said metal of said particles is different from said material of said parent part.

28. A method for making a body for a keylocking threaded insert having a given configuration with axial locking grooves, said method comprising:
(a) mixing metal particles having a particle size of less than 20 microns with a plastic binder;
(b) forming said mixture into feedstock pellets;
(c) providing a mold with said configuration;
(d) injection molding said mixture in said mold to form an enlarged version or green part of said insert;
(e) heating said version to remove said binder; and,
(f) then heating said version to sinter said particles and reduce said version to the desired size.

29. A mold for injection molding a body of a keylocking threaded insert, said mold having two closing elements with an inner semi-cylindrical section with matching thread projections defining a continuous mirror image of a cylindrical thread facing a old cavity and abutting radial surfaces defining a parting line, an axially retractable elongated insert intersecting said parting line with profiles defining axial grooves intersecting said cylindrical thread and a rotatable core member concentric with said mirror image and removable from said mold cavity.
